(19) United States
(12) Patent Application Publication
(10) Pub. No.: US 2006/0181511 A1
(43) Pub. Date: Aug. 17, 2006

(54) Touchpad integrated into a key cap of a keyboard for improved user interaction

(76) Inventor: Richard Woolley, Orem, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/351,284

(22) Filed: Feb. 9, 2006

Related U.S. Application Data
(60) Provisional application No. 60/651,527, filed on Feb. 9, 2005.

(51) Int. Cl. G09G 5/08

(52) U.S. Cl. 345/160

(57) ABSTRACT

A miniature touchpad disposed underneath the surface of a single key cap that is disposed in a keyboard, wherein the key cap touchpad provides proximity sensing through the material of the key cap to the key cap surface, wherein a user moves a finger across the key cap surface in order to manipulate a cursor on a display screen, scroll through items in a list, navigate through web pages, or other functions typically associated with a full-function touchpad.

### CROSS REFERENCE TO RELATED APPLICATIONS

This document claims priority to and incorporates by reference all of the subject matter included in the provisional patent application docket number 3245.CIRQ.PR, having Ser. No. 60/651,527 and filed on Feb. 9, 2005.

### BACKGROUND OF THE INVENTION

1. Field of the Invention

This invention relates generally to touchpads and integrated cursor manipulation devices. More specifically, the present invention describes a touchpad that is integrated into a single key of a keyboard to thereby provide convenient touchpad functionality without having to remove fingers from a keyboard.

2. Description of Related Art

To perform cursor control on a display screen of an electronic device, there are various devices that provide this type of functionality. For example, in many laptop computers today there are two different integrated pointing devices that allow the user to control cursor movement.

The first of these devices is a small “pointer stick” or “think stick” device that is disposed somewhere in the middle of a QWERTY keyboard layout. This pointer stick can be thought of as a very small joystick that a user “leans” against to cause a cursor to move in the direction of force applied by a user to the pointer stick. The pointer stick is very small, and is disposed between several keys of the keyboard. The pointer stick is typically covered by a soft rubber pad to cushion the user's finger as the finger applies a force. The pointer stick has even been manufactured in stand-alone keyboards to provide this same functionality for desktop computer users.

One of the main advantages of the pointer stick is that it enables the user to perform pointing operations without relocating a finger or hand away from the keyboard in order to make contact with another pointing device that performs cursor manipulation functions.

Besides the pointer stick, other cursor manipulation devices include touchpads, a computer mouse, and a trackball. It is interesting to note that the pointer stick type device is not as common or popular as touchpads in laptop computers, or as common as a computer mouse when using stand-alone keyboards. Similarly, the trackball has not found widespread use.

While the pointer stick type of cursor control device has the advantage of being disposed in the middle of the keyboard, it also has some inherent disadvantages to its design. For example, the physical structure of the pointer stick is that of a very small rod. The pointer stick may have sharp edges that serve as an irritant that can be painful to push against. Even if the edges are rounded, it can still be relatively sharp simply because of its small size. Furthermore, the soft rubber coverings or nubs that are typically disposed over the top of the pointer stick wear out quickly, and can pop off easily and be lost. If the user does not have a spare nub handy, the user has no choice but to push the finger directly against the pointer stick without any cushion to protect the finger.

Another disadvantage of the pointer stick is that it can be difficult to try and perform fine adjustments to cursor position because the user has to very carefully control the amount and the direction of pressure that is applied. Some users are simply incapable of controlling the very subtle differences in pressure that are required to control cursor movement.

Accordingly, what is needed is a device that can be integrated into a keyboard that does not require a user to remove a finger or hand from the keyboard in order to perform cursor manipulation. It would be another advantage to provide a device that could also perform functions in addition to cursor control, such as those functions commonly associated with touchpads, such as scrolling.

To understand the touchpad technology used in the present invention, it is useful to examine one embodiment of such technology. An important aspect of the present invention is the use of capacitance sensing technology for proximity sensing through the key cap. Touchpad technology of CIRQUE® Corporation has been adapted to perform this function. However, it should be remembered that the touchpad technology may be further modified for this particular invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

### BRIEF SUMMARY OF THE INVENTION

It is an object of the present invention to dispose a touchpad within a single key cap of a keyboard, without having to modify a typical keyboard layout.

It is another object to enable the key cap touchpad to provide a plurality of standard touchpad functions, including cursor control, scrolling capabilities, and navigation through web pages.

In a preferred embodiment, the present invention is a miniature touchpad disposed underneath the surface of a single key cap that is disposed in a keyboard, wherein the key cap touchpad provides proximity sensing through the material of the key cap to the key cap surface, wherein a user moves a finger across the key cap surface in order to manipulate a cursor on a display screen, scroll through items in a list, navigate through web pages, or other functions typically associated with a full-function touchpad.

In a first aspect of the invention, a key cap touchpad is disposed on the underside of the key cap to thereby enable proximity sensing through the key cap to the key cap surface.

In another aspect of the invention, a first mode of key cap touchpad operation enables large scale actuations using relatively small movements of a finger across the key cap surface, and a second mode of operation enables relatively small scale actuations using the same relatively small movements of the finger.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a touchpad as taught be the prior art, and which is adapted to function with the present invention.

FIG. 2 is a perspective view of a keyboard having a key cap touchpad disposed directly underneath a key cap to enable proximity sensing through the key cap.

FIG. 3 is a close-up perspective view of the underside of a key cap showing a key cap touchpad attached to the underside of a key cap by any convenient means, such as an adhesive.

FIG. 4 is another perspective view, but of the top surface of an H key cap, wherein a flexible portion of the touchpad substrate is seen extending outwards from the inside of the key cap.

FIG. 5 is a perspective view of a finger moving over a key cap having a key cap touchpad disposed therein.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

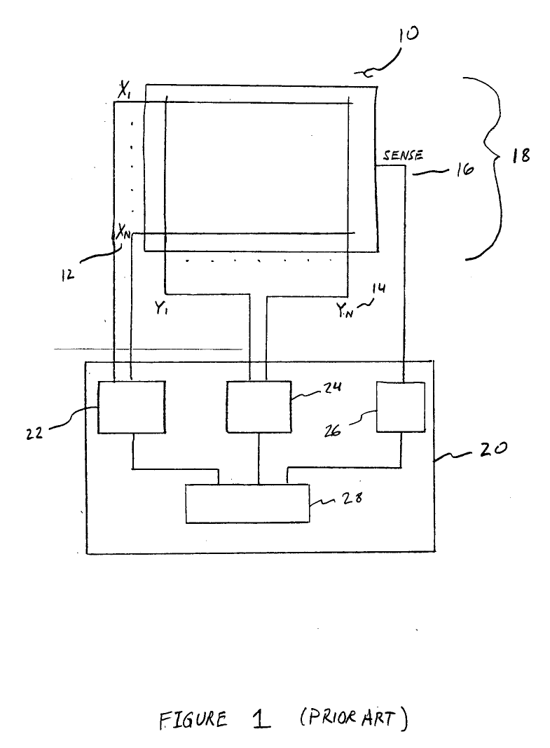

A capacitance sensitive touchpad that is used to provide the touchpad functionality of the present invention can be implemented using different types of substrates for the X and Y electrode grids described in FIG. 1. A first type of substrate is made from PC board material. The X and Y electrodes are disposed in layers on and/or within the PC board material. The PC board material is rigid, and thus an alternative substrate material will likely be more suitable for use in the present invention because it is more likely that the key cap surface will be slightly curved.

Accordingly, a flexible substrate material can be used as described in U.S. Pat. No. 6,680,731. In this patent, assigned to CIRQUE® Corporation, a flexible substrate for the X and Y electrode grids enables a capacitance sensitive touchpad to conform to the contours of an arcuate surface. Thus, a capacitance sensitive touchpad manufactured with a flexible substrate can easily be disposed on the underside of a key cap of the present invention as will be described.

FIG. 1 is provided as a top view of a small portion of the keys (referred to hereinafter as “key caps” to denote the physical structure) and thus the keyboard layout of a QWERTY keyboard. The key caps 30 are shown as tapering from a smaller top surface 32 down to a wider base 34. It should be noted that this illustration is only one example, and not required for the present invention. All that is necessary is that the underside of at least one key cap 30 be accessible so that a key cap touchpad can be disposed thereon.

A key cap 30 is typically a molded key on a keyboard that typically has a letter printed on the top surface 32. The top surface 32 of the key cap 30 may be slightly indented to form an arcuate surface, or it can be relatively planar. Key caps 30 are not limited to letters only, but are any of the keys that can be disposed on a keyboard and which may have a top surface that is relatively square, round, form an ellipsoid, or be elongated so as to form a rectangular shape.

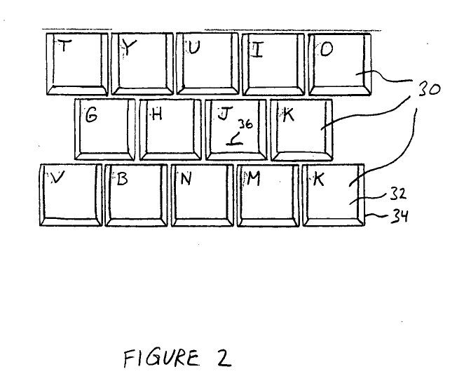

Note that in FIG. 2, a small line 36 is visible on the key cap 30 designated with the letter “J”. The line 36 is typically raised so that a user can feel the line when moving fingers over a keyboard. The Letter “J” is so designated because it is a “home” key for the right hand. The “J” key cap 30 is also a likely candidate for use as the key for the key cap touchpad of the present invention. However, it should be remembered that any key cap 30, including non-letter key caps 30 may be used.

It should be noted that there is no outward indication that the key cap touchpad is present within the key cap 30, unless attention is intentionally drawn to the key cap, for example, by changing its color, marking the top surface, or any other visual means. Furthermore, the key cap 30 can be altered to provide a different tactile feeling as compared to nearby key caps 30 to further assist a user in locating the key cap touchpad without having to look at the keyboard.

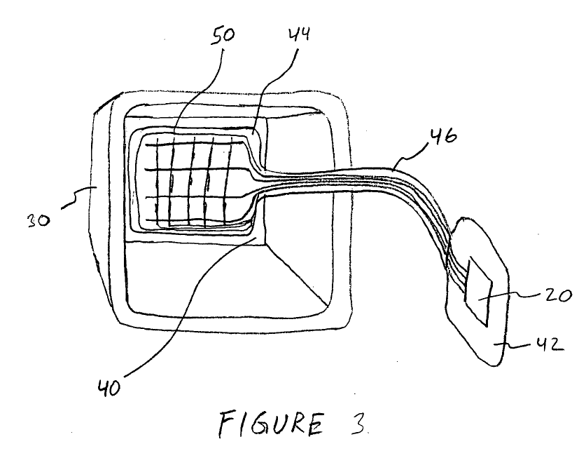

FIG. 3 is provided to show more detail of the physical placement of a key cap touchpad within a key cap 30 of the present invention. In this embodiment, a smaller than typical touchpad is disposed on the underside 40 of a key cap 30. The key cap 30 is shown on its side so that the underside 40 of the key cap is exposed to view.

The key cap touchpad 50 is shown generally with a plurality of X and Y electrodes 12, 14 shown exposed. The electrodes 12, 14 are shown as leading to touchpad circuitry 20 that is disposed on a second substrate 42 that is separate from the substrate 44 on which the electrodes 12, 14 are disposed. The electrodes 12, 14 move from the flexible substrate 44 to the touchpad circuitry 20 via a flexible substrate 46 that enables the touchpad circuitry 20 to be near but not directly adjacent to the electrodes 12, 14.

Note that the touchpad circuitry 20 and its substrate 42 could possibly fit up inside the key cap 30 if the key cap is sufficiently large enough. In addition, the substrate 44 may be comprised of a substrate that is flexible or rigid, depending upon the key cap 30 being used. The flexible substrate 44 is especially useful if the key cap surface 32 is arcuate. Such a touchpad will be similar to the touchpads already manufactured by CIRQUE® Corporation.

The key cap touchpad 50 is coupled to the underside of the key cap 30 using an adhesive or other mechanical means. An example of a mechanical scheme is a physical wedge or other obstruction that might fit tightly into the space, and also allow for the substrate 46 to extend through the obstruction to reach touchpad circuitry 20.

Touchpad circuitry 20 will typically be located in a group of integrated circuits that are disposed on a material being used for the touchpad substrate 44. The touchpad circuitry 20 will typically be anchored to a keyboard substrate (not shown) within a keyboard.

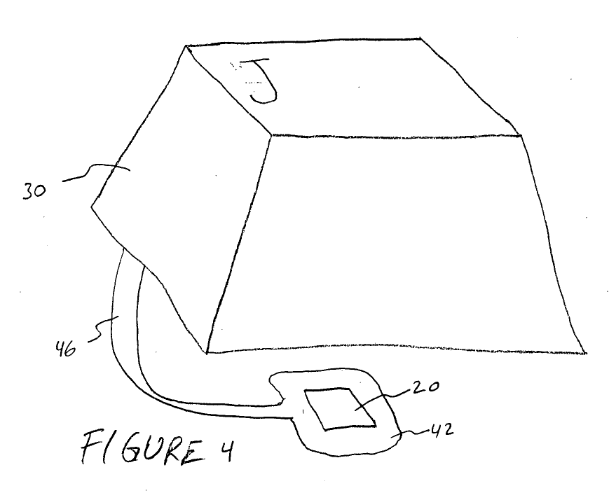

FIG. 4 is another perspective view, but of the key cap surface 32 of the “J” key cap 30, wherein a flexible substrate 46 is seen extending out from beneath the key cap. The touch circuitry 20 is shown disposed on its own substrate 42. The touch circuitry 20 can be disposed on a rigid or flexible substrate.

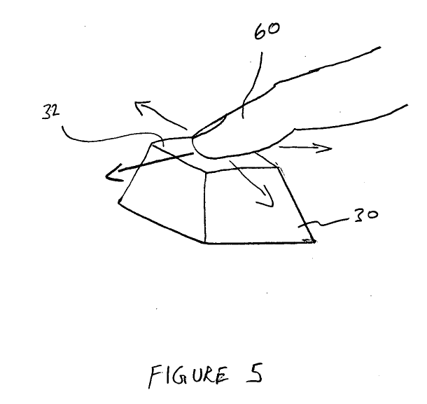

Use of the key cap touchpad 50 as taught by the present invention is straightforward. As shown in FIG. 5, a user has a finger 60 touching the top surface 32 of the key cap 30. The key cap 30 has disposed on the underside the key cap touchpad 50. In this example, the key cap 30 has an arcuate top surface 32, and a correspondingly arcuate underside (not shown). In this embodiment, the substrate 42 of the key cap touchpad 50 is flexible, thereby enabling the key cap touchpad to conform to the arcuate underside of the key cap 30.

It is envisioned that the key cap touchpad 50 is not an absolute positioning system, but a relative positioning system. In other words, if the key cap touchpad 50 is being used to control movement of a cursor on a display screen, the top surface 32 of the key cap 30 is typically used to cause the cursor to move by repeated motions of 1) setting the finger down on the key cap surface 32, and 2) moving the finger along the key cap surface in a desired direction of motion for the cursor.

If the cursor does not reach its desired location on the display screen after steps 1 and 2 are complete, the user 3) lifts the finger off the key cap surface 32, 4) moves the finger over a new location of the key cap surface, and then 3) repeats steps 1 and 2 above until the cursor reaches a desired location.

It is noted that the surface area of a typical key cap 30 is relatively small in comparison to a typical touchpad used with, for example, a notebook computer. Accordingly, it is possible to adjust the degree of movement of the cursor that is caused by movement of the finger 60 on the key cap surface 32. Thus, a relatively small movement of the finger 60 can be made to correspond to a much larger degree of movement of the cursor.

It is envisioned that it may be desirable to have more than one defined degree of movement for the user. In other words, it may be desirable to operate the key cap touchpad 50 such that large movements of a cursor are possible in one mode, but then provide the ability to switch to a second mode wherein much more precision is available to the user. Thus, it is envisioned that a simple command or switch be provided to the user wherein the user can quickly switch between a first mode and a second mode of cursor sensitivity. In the first mode, the user can move the cursor large distances in response to very small movements of a finger across the key cap surface 32. However, in a second mode of operation, the user can move the cursor much smaller distances in response to the same small movements by the finger 60 across the key cap surface 32. In this way, the present invention enables rapid cursor movement and small cursor movement when desired.

The means for switching between the first mode and the second mode of key cap touchpad 50 operation can be implemented as a hardware switch or as a software switch. For example, it could be switched by pressing a designated function key.

One important aspect of the key cap touchpad is that the touchpad will at least provide one function commonly associated with full-function touchpads, and will likely include many different touchpad functions. These functions include but should not be considered limited to cursor control, scrolling, navigation of web pages, fingerprint identification, etc.

It should be noted that this small key cap touchpad 50 is not limited to being disposed within a key cap 30 of a keyboard. There are many devices, such as portable electronic appliances including cameras, camcorders, personal digital assistants, mobile telephones, etc., that can all take advantage of a miniature touchpad that can provide many different levels of touchpad functionality.

Other functions of the key cap touchpad 50 include the ability to perform touchpad functions without having to remove a finger or hand from the keyboard. In addition, no special re-design or modification of a keyboard would be needed, as is the case for a pointer stick. Advantageously, the key cap touchpad 50 operates through the plastic or other material of the key cap 30. The only limitation for key cap material is that it not interfere with the capacitance sensitive measurements performed by the key cap touchpad 50.

Modifications in the design of existing CIRQUEυ Corporation touchpads include reducing the total number of electrodes that are present because of the smaller physical area being occupied by the key cap touchpad 50. Firmware modifications will also be needed in order to perform accurate position sensing.

It should be noted that the present invention can be implemented with any touchpad technology that enables a single key cap to provide functionality of a touchpad. Accordingly, the present invention may be implemented using capacitance-sensing, pressure sensing, infra-red, optical, and other touchpad technologies that enable determination of the location of an object that is touching or in proximity to a surface of the key cap.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A key cap touchpad comprised of:
a key cap manufactured using a material that does not interfere with capacitance measurements of a touchpad;
a capacitance sensitive key cap touchpad coupled to an underside of the key cap, to thereby perform proximity sensing of objects on or near a surface of the key cap;
touchpad sensor circuitry coupled to the key cap touchpad; and
firmware associated with the touchpad that provides at least one touchpad function.

2. The key cap touchpad as defined in claim 1 wherein the key cap is further comprised of a keyboard, wherein the key cap is disposed within the keyboard, and wherein the key cap provides dual functionality as a key cap touchpad and as a keyboard key that when pressed results in a character or command associated with the key to be transmitted as in typical keyboard operation.

3. The key cap touchpad as defined in claim 1 wherein the key cap is further comprised of a keyboard, wherein the key cap is disposed within the keyboard, and wherein the key cap provides the dedicated functionality of a key cap touchpad.

4. The key cap touchpad as defined in claim 1 wherein the key cap touchpad is further comprised of an activation circuit, wherein the key cap touchpad can be toggled between an inactive state and an active state using the activation circuit.

5. The key cap touchpad as defined in claim 4 wherein the activation circuit is further comprised of a dedicated switch for toggling between the inactive state and the active state.

6. The key cap touchpad as defined in claim 1 wherein the key cap touchpad is further comprised of an adhesive, wherein the adhesive couples a sensing surface of the capacitance sensitive touchpad to an underside of the key cap.

7. The key cap touchpad as defined in claim 1 wherein the key cap touchpad is further comprised of a mechanical wedge, wherein the mechanical wedge holds the capacitance sensitive touchpad against an underside of the key cap.

8. The key cap touchpad as defined in claim 1 wherein the capacitance sensitive touchpad is further comprised of:
an arcuate surface for the key cap and a corresponding arcuate underside; and
a flexible substrate of the capacitance sensitive touchpad that conforms to the arcuate underside of the key cap.

9. The key cap touchpad as defined in claim 1 wherein the capacitance sensitive touchpad is further comprised of:
a planar surface for the key cap and a corresponding planar underside; and
a planar substrate for the capacitance sensitive touchpad that conforms to the planar underside of the key cap.

10. A method for performing at least one touchpad function using a single key cap of a keyboard, said method comprising the steps of:
(1) providing a key cap, a capacitance sensitive key cap touchpad coupled to an underside of the key cap to thereby perform proximity sensing of objects on or near a surface of the key cap, touchpad sensor circuitry coupled to the capacitance sensitive touchpad, and firmware associated with the touchpad that provides at least one touchpad function; and
(2) moving a finger across the key cap surface to thereby perform the at least one touchpad function.

11. The method as defined in claim 10 wherein the method further comprises the steps of:
(1) disposing the key cap in a keyboard; and
(2) providing dual functionality for the key cap as the key cap touchpad and as a keyboard key that when pressed results in a character or command associated with the key to be transmitted as in typical keyboard operation.

12. The method as defined in claim 10 wherein the method is further comprised of the steps of:
(1) disposing the key cap in a keyboard; and
(2) providing dedicated functionality for the key cap such that the key cap exclusively provides the functionality of a key cap touchpad.

13. The method as defined in claim 10 wherein the method further comprises the step of including an activation circuit to control actuation of the key cap touchpad, wherein the key cap touchpad can be toggled between an inactive state and an active state using the activation circuit.

14. The method as defined in claim 13 wherein the step of providing an activation circuit is further comprised of the step of a dedicated switch for toggling between the inactive state and the active state.

15. The method as defined in claim 10 wherein the method is further comprised of the step of coupling a sensing surface of the key cap touchpad to an underside of the key cap using an adhesive.

16. The method as defined in claim 10 wherein the method is further comprised of coupling a sensing surface of the key cap touchpad to an underside of key cap by using a mechanical wedge.

17. The method as defined in claim 10 wherein the method further comprises the steps of:
(1) forming the key cap with an arcuate surface and a corresponding arcuate underside; and
(2) providing a flexible substrate for the key cap touchpad that conforms to the arcuate underside of the key cap.

18. The method as defined in claim 10 wherein the method further comprises the steps of:
(1) forming the key cap with a planar surface and a corresponding planar underside; and
(2) providing a substrate for the key cap touchpad that conforms to the planar underside of the key cap.

19. The method as defined in claim 10 wherein the method further comprises the step of enabling the key cap touchpad to provide a touchpad function of cursor control on a display screen.

20. The method as defined in claim 19 wherein the step of providing cursor control further comprises the steps of:
(1) providing a first mode of key cap touchpad operation, wherein movement of a finger across the key cap surface causes relatively large movements of a cursor across a display screen; and
(2) providing a second mode of key cap touchpad operation, wherein movement of the finger across the key cap surface causes relatively small movements of the cursor across the display screen.

21. The method as defined in claim 20 wherein the method further comprises the step of providing a switching means for enabling a user to rapidly switch between the first mode and the second mode of key cap touchpad operation.

22. The method as defined in claim 10 wherein the method further comprises the step of enabling the key cap touchpad to provide a touchpad function of scrolling through a list shown on a display screen.

23. The method as defined in claim 22 wherein the step of providing scrolling control further comprises the steps of:
(1) providing a first mode of key cap touchpad operation, wherein movement of a finger across the key cap surface causes relatively rapid movements within the list shown on the display screen; and
(2) providing a second mode of key cap touchpad operation, wherein movement of the finger across the key cap surface causes relatively small movements within the list shown on the display screen.

24. The method as defined in claim 23 wherein the method further comprises the step of providing a switching means for enabling a user to rapidly switch between the first mode and the second mode of key cap touchpad operation.
